(19) United States
(12) Patent Application Publication
(10) Pub. No.: US 2010/0072725 A1
(43) Pub. Date: Mar. 25, 2010

(54) ACTUATOR FOR GENERATING A ROTATIONAL POSITIONING MOVEMENT

(75) Inventors: Paul Woellhaf, Friedrichshafen (DE); Roland Doerner, Wittighausen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/517,363

(22) PCT Filed: Dec. 3, 2007
(86) PCT No.: PCT/EP07/63112

§ 371 Date: Jun. 3, 2009

(30) Foreign Application Priority Data
Dec. 9, 2006 (DE) 10 2006 058 133.4

(51) Int. Cl. F16H 37/00; F16H 1/20; F16H 1/28; B60G 21/055; B62D 5/04; B66D 1/12

(52) U.S. Cl. 280/124.107; 475/343; 74/413; 180/444; 254/362

(57) ABSTRACT

The present invention relates to an actuator for generating a rotational positioning movement, wherein the actuator comprises an electric motor (1) and a reduction gear (2) which consists of two assemblies (4, 5). The first assembly (4) is formed by a gear of the harmonic, cycloid or wobble, type and the second assembly (5) by a gear of the single-step or multistep planetary or Wolfrom type, whereby both assemblies (4, 5) are so tuned to each other, that the reduction gear (2) is not self-locking.

This application is a National Stage completion of PCT/EP2007/063112 filed Dec. 3, 2007, which claims priority from German patent application serial no. 10 2006 058 133.4 filed Dec. 9, 2006.

### FIELD OF THE INVENTION

The present invention relates to an actuator for generating rotational positioning movement.

### BACKGROUND OF THE INVENTION

Actuators are frequently used in vehicles for generating positioning movements which are controlled by the system or the driver. Actuators may, for example, adjust a vehicle seat, support the steering force or adjust the ride height of the chassis to the driving speed. The energy required for this purpose is normally provided in electric, hydraulic or pneumatic form, whereby electric actuators may be cost-effectively positioned in nearly any place in the vehicle because of the easy transfer of the electric energy from the energy source to the actuator. Moreover, nearly all types of vehicles have an electric energy source, like a generator or battery, by means of which, compared to pneumatic or hydraulic actuators, electric actuators are easier to integrate in existing vehicle systems.

Besides an electric motor, electric actuators for generating rotational positioning movement mostly comprise a reduction gear which reduces the speed at the output shaft of the electric motor to a desirable level or increases the torque generated by the electric motor. In this respect, EP 1 627 757 A1 discloses an electric actuator for generating rotational positioning movement between halves of a vehicle stabilizer bar, the actuator consisting of a brushless electric motor, a reduction gear and a case surrounding the electric motor and the reduction gear. A two-step planetary gear or a single-step well gear (also known as harmonic gear) is disclosed as reduction gear. Since the voltage in the power system of a vehicle, as well as the maximum current that can be tapped, is usually very limited, the electric motor can only generate a low torque for which reason the reduction gear increases the torque generated by the electric motor to the required level by means of a high gear ratio. For this purpose, single-step or multistep planetary gears comprise multiple rotating elements which increase the price of the reduction gear because of its complexity and reduce the positioning speed because of the mass inertia. For this purpose, a harmonic drive is, in fact, less complex and, because of the lower mass inertia, has a high positioning speed for accomplishing the required high gear ratios with higher efficiency and high transmission capacity, but its installation space compared to the consecutively arranged planetary gears is less compact, i.e. it has a comparatively large outer diameter. Therefore, a single-step harmonic gear may be disadvantageous, considering the cramped installation conditions available in a vehicle.

### SUMMARY OF THE INVENTION

The object of the present invention is therefore to create an actuator for generating rotational positioning movements which is suitable for the cramped installation conditions of a vehicle and has a high positioning speed.

Accordingly, an actuator for generating rotational positioning movement comprises an electric motor and a reduction gear connected to an output element of the motor.

In order to achieve an increase in the positioning speed of the actuator considering the installation conditions prevailing in a vehicle, like limited voltage, current and installation space, the masses mobilized in the reduction gear have to be reduced and the efficiency of the reduction gear has to be increased, and the positioning forces acting against the actuator have to be utilized for which reason the reduction gear according to the present invention is designed such, that it is not self-locking. Since a single reduction gear of the harmonic, cycloidal or wobble type has a comparatively large diameter for the gear ratio required for generating the required torque, has no acceptable efficiency and is self-locking from experience, and unadulterated stepped, planetary or Wolfrom gears have too-large a mass inertia, the reduction gear of the actuator according to the present invention comprises two component assemblies. The first assembly comprises a single-step harmonic, cycloidal or wobble gear, and the second assembly comprises a single-step or multistep planetary, stepped or Wolfrom gear. Both assemblies are interconnected such, that the required total gear ratio results from a high efficiency and a compact installation space, and the reduction gear is simultaneously not self-locking. Compared to an unadulterated planetary, stepped or Wolfrom gear, the reduction gear has low complexity and inertia, resulting in a drop in the peak current consumption of the electric motor. As a result, it may be designed with a smaller size which allows a further reduction in the required installation space.

An embodiment of the present invention provides, that the first assembly is arranged between the electric motor and the second assembly, whereby the first assembly, i.e. the harmonic, cycloidal of wobble gear, is arranged on the side of the reduction gear having the lower torque. Since the torque placed on the first assembly is consequently reduced, it can be designed more compact, i.e. the diameter of the first assembly may be considerably reduced. It is especially advantageous, if the gear ratio of the first assembly is below 1:40, as higher gear ratios in practice cause unfavorable efficiency and self-locking. In addition, it is advantageous, if the second assembly comprises at least one planet carrier, at least one sun gear and, if necessary, at least one ring gear, whereby one of the planet carriers or one of the ring gears serves as a preferred output element of the reduction gear, from which the rotational movements can be tapped.

A preferred application of the actuator according to the present invention provides, that it is used as part of a vehicle stabilizer bar which is divided in two parts and electromechanically adjustable for roll stabilization or ride height control. For roll stabilization, a single actuator according to the present invention is inserted between both parts of the vehicle stabilizer bar, as a result of which in case of rolling movement, both parts may rotate against one another such that they generate movement in the opposite direction of the rolling movement thus attenuating or eliminating the rolling movement. In an especially preferred embodiment of the present invention a first part of the vehicle stabilizer bar is connected stationary to the output element of the reduction gear of the actuator, and a second part of the vehicle stabilizer bar is connected to the actuator case.

For controlling the ride height of the vehicle, an actuator according to the present invention is connected in a rotationally fixed manner to a vehicle body, as well as to at least one of the parts of the vehicle stabilizer bar, as a result in case of a rotational positioning movement the actuator may lift the vehicle body on both sides and/or on the vehicle side that is operatively connected to the part of the stabilizer bar. Thus, two actuators according to the present invention may each be connected to a part of the vehicle stabilizer bar and coupled to one another electronically or mechanically, such that for controlling the ride height the actuators generate rotational movement of both parts of the stabilizer bar that is aligned with the vehicle body. Or an actuator according to the present invention may also be connected to both parts of the stabilizer bar such, that it twists both parts relative to the vehicle body by means of a rotational positioning movement.

In another preferred embodiment, the actuator according to the present invention is used for reinforcing the steering force generated by the driver for changing the driving direction. For this purpose, the output element of the actuator is mechanically coupled to a push rod of the steering mechanism, for example a steering rod or a tie rod, and applies a force on the push rode in the direction of the steering movement, when the driver makes a steering movement. The conversion of the rotational positioning movement of the actuator to a linear movement of the push rod required for this purpose may, for example, be accomplished by means of a lever or a spindle nut and a spindle. The force applied by the actuator may additionally be adjusted to the momentary vehicle speed or to the steering force applied by the driver by controlling the output of the electric motor of the actuator by means of sensors.

Besides the described examples, the actuator according to the present invention may be used in multiple applications, where rotational positioning movement is required. By way of example the use of the actuator in a winch could still be mentioned, where the actuator is used as a compact motor gear unit for retracting or extending a tensioned winch rope. In this case it is especially advantageous, that the reduction gear of the actuator is not self-locking, while featuring a high gear ratio and good efficiency at the same time, as a result of which, on the one hand, the tensioned winch rope may be wound off the winch without the electric motor having to generate kinetic energy and, on the other hand, heavy loads may be moved even at a low motor output. In cases where the actuator according to the present invention is used in technical areas, where low actuating forces develop, for example, using the actuator for adjusting a vehicle seat or for adjusting the ventilation flaps of a ventilation system in a vehicle, the reduction gear may be made in part or completely of plastic for weight and cost saving reasons. In case it is necessary that the rotational positioning movement of the actuator should be executed very accurately or measured very accurately, it may additionally comprise an angle sensor which can be disposed directly on the electric motor, between the electric motor and the reduction gear, in the reduction gear, or at the output element of the reduction gear.

### BRIEF DESCRIPTION OF THE DRAWINGS

The present invention will hereafter be explained in more detail by means of examples and drawings from which further advantageous embodiments will become apparent. Schematic diagrams respectively show in

FIG. 1 an actuator according to the present invention having a harmonic gear and a two-step planetary gear;

FIG. 2 an actuator according to the present invention having a harmonic gear and a single-step Wolfrom gear in modular design; and

FIG. 3 an actuator according to the present invention of an electromechanically adjustable vehicle stabilizer bar with a harmonic gear and a sing-step Wolfrom gear.

### DETAILED DESCRIPTION OF THE PREFERRED EMBODIMENTS

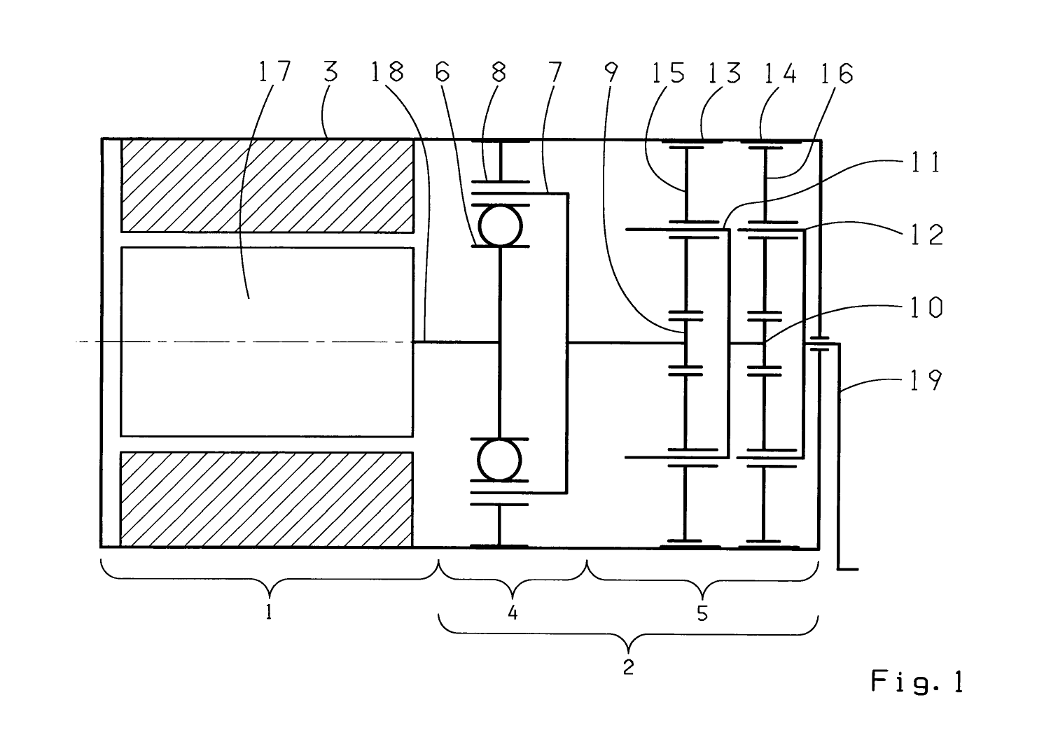

The actuator shown in FIG. 1 for generating rotational positioning movements comprises an electric motor 1 and a reduction gear 2 which are mounted in a common housing 3. The reduction gear 2 consists of two assemblies 4, 5, the first assembly 4 consisting of a well-known harmonic gear having a wave generator 6, an elastic wheel 7 and a rigid wheel 8, and the second assembly 5 consisting of a well-known two-step planetary gear having two sun gears 9, 10, two planet carriers 11, 12, two ring gears 13, 14 and at least two planetary gears 15, 16. For the generation of rotational positioning movement, the motor output shaft 18 attached to the rotor 17 of the electric motor 1 actuates the wave generator 6 of the harmonic gear, generating the rotation of the elastic wheel 7 against the rotational direction of the wave generator 6 owing to the difference in the number of teeth between the elastic wheel 7 and the rigid wheel 8. The elastic wheel 7 forms the output element of the harmonic gear which in turn acts upon the first sun gear 9 of the two-step planetary gear. The planetary gear 9 moves the first planetary gears carried by the first planet carrier 11 along the first ring gear 13, consequently setting the first planet carrier 11 in rotation. It is In turn used as an output element of the first planetary gear and actuates the second sun gear 10 which moves the second planetary gear 16 along the second ring gear 14. The movements of the second planetary gears 16 generate the rotational movement of the second planet carrier 12 used as output element of the reduction gear, the second planet carrier 12 being connected in a rotationally fixed manner to a lever 19 protruding from the actuator. The rotational positioning movement may be tapped from there, whereby the output element of the reduction gear may alternatively also be connected to a ball nut or pinion which may also be used for converting the rotational positioning movement to linear positioning movement.

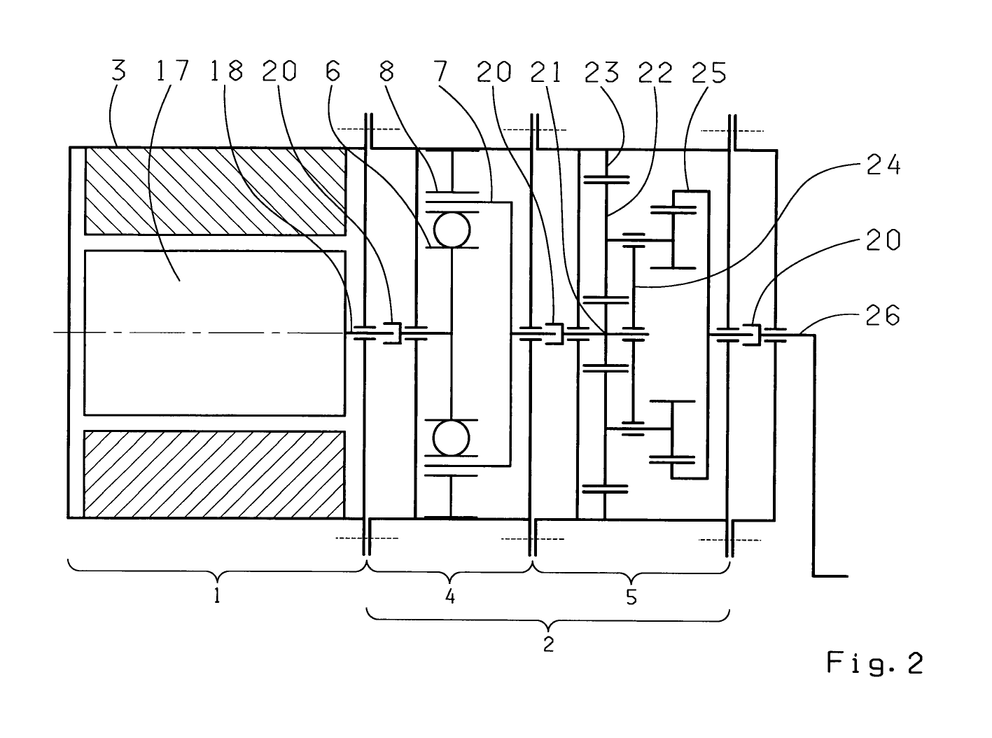

Besides the electric motor 1, the actuator illustrated in FIG. 2 comprises a reduction gear 2 consisting of a harmonic gear and a one-step Wolfrom gear. The entire actuator is configured in modular design, whereby the electric motor 1, the first assembly 4 consisting of the harmonic gear, and the second assembly 5 consisting of the Wolfrom gear, as well as the output element of the actuator, respectively form one module. Therefore, the actuator may be adjusted in a modular manner to the specific operating conditions, for example, by means of a more powerful electric motor 1 or a second assembly with a higher gear ratio or higher stability. In addition, defective or damaged modules may be easily replaced. The individual assemblies 4, 5 are connected to one another via claw clutches, for example, which allow any consecutive alignment of the assemblies, especially the modules of the assemblies 4, 5. According to the present invention, the gear types of the assemblies 4, 5 may be freely varied by consecutively aligning the modules of the assemblies 4, 5 in any order, for example, the first assembly may consist of a module with a harmonic, cycloidal or wobble gear and the second assembly of a consecutively arranged first module with a single-step planetary gear and a second module with a two-step planetary gear. In theory, it would also be possible to arrange two or more modules consecutively with a harmonic, cycloidal or wobble gear each which, however, has no technical advantages compared to a single, slightly larger harmonic, cycloidal or wobble gear and therefore is not the subject matter of the present invention.

In conjunction with the first assembly of FIG. 1, the first assembly 4 shown in FIG. 2 consists of a wave generator 6 as input element, a rigid wheel 8 and an elastic wheel 7 as output element. The wave generator 6 is connected to the motor output shaft 18 via the clutch 20. The elastic wheel 7 is in turn connected to a sun gear 21 used as input element of the Wolfrom gear via another clutch 20, where the sun gear 21 drives at least one planetary gear 22 along a first stationary ring gear 23 during rotational movement. The planetary gear 22 in turn rotates on the planet carrier 24 that is mounted so as to rotate on the sun gear 21 and actuates a second ring gear 25 that is mounted so as to rotate in the housing 3, whereby the rotational movement of the planetary gear 22 around its own axis and the rotational movement of the planet carrier 24 around the axis of the sun gear 21 superimpose on the rotation of the second ring gear 25. The second ring gear 25 is used as output element of the reduction gear 2 and is connected to the output element of the actuator by means of a third clutch 20, the output element being configured, for example, as a lever 26 mounted in a case 3.

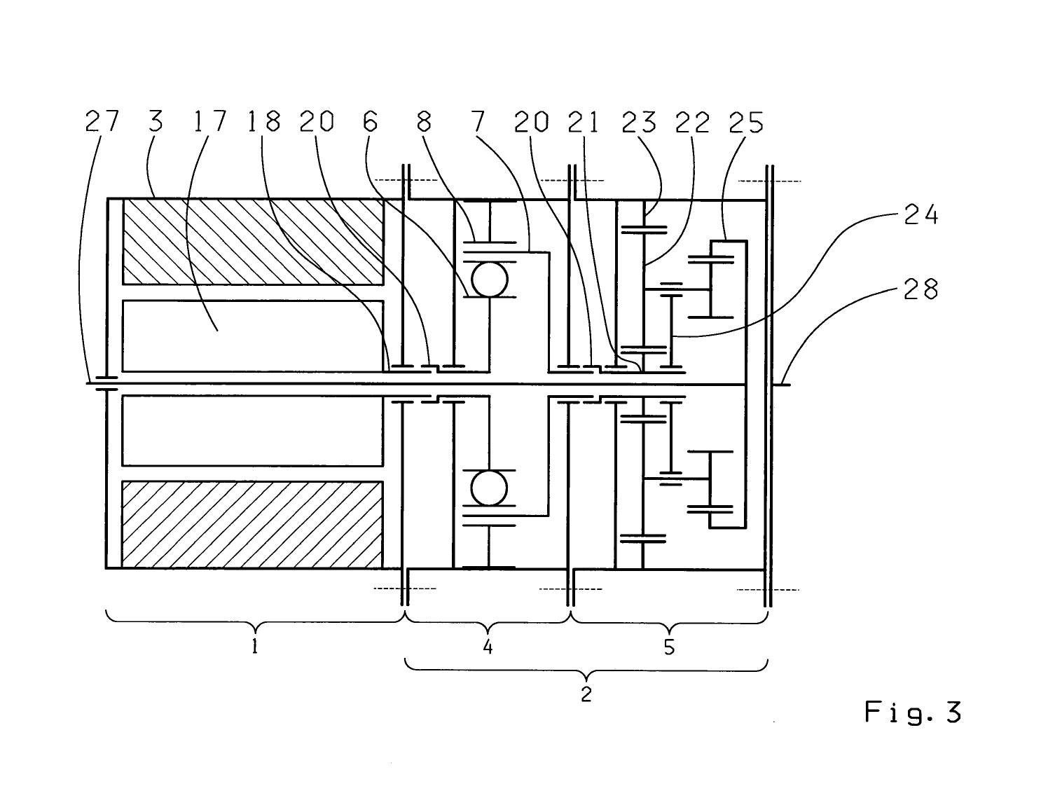

FIG. 3 shows a variation of the actuator according to the present invention illustrated in FIG. 2 which is suitable for use in an adjustable vehicle stabilizer bar. The gear lay out of the reduction gear 2 fully corresponds to the actuator of FIG. 2. In order not to have a negative effect on the springiness of a vehicle having an adjustable vehicle stabilizer bar divided in two parts 27, 28, both parts 27, 28 of the stabilizer bar together should have the same or similar springiness as a one-piece nonadjustable vehicle stabilizer bar for which reason they should be arranged as close to one another as possible. The second ring gear 25 forms the output element of the actuator of the Wolfrom gear which is connected stationary to the first part 27 of the stabilizer bar. It is directed out of the housing 3 along the longitudinal axis of the actuator through both assemblies 4, 5, the clutches 20 and the output shaft 18, as well as through the rotor 17 of the electric motor 1. The second part 28 of the stabilizer bar is, on the other hand, connected in a fixed manner with the side of the housing 3 opposite the point where the first part 27 of the stabilizer bar emerges from housing, whereby the ends of the parts 27, 28 of the stabilizer bar are close to one another and thus the common length of the parts 27, 28 of the stabilizer bar corresponds to the approximate length of a one-piece stabilizer bar.

### REFERENCE NUMERALS

1 Electric motor
2 Reduction gear
3 Housing
4 First assembly
5 Second assembly
6 Wave generator
7 Elastic wheel
8 Rigid wheel
9 First sun gear
10 Second sun gear
11 First planetary carrier
12 Second planetary carrier
13 First ring gear
14 Second gear ring
15 First planetary gear
16 Second planetary gear
17 Rotor of the electric motor
18 Motor output shaft
19 Lever
20 Clutch
21 Sun gear of the Wolfrom gear
22 Planetary gear of the Wolfrom gear
23 First ring gear of the Wolfrom gear
24 Planet carrier of the Wolfrom gear
25 Second ring gear of the Wolfrom gear
26 Lever
27 First part of the stabilizer bar
28 Second part of the stabilizer bar

1-10. (canceled)

11. An actuator for generating a rotational positioning movement, the actuator comprises:
an electric motor (1), and
a reduction gear (2) and the motor (1) being connected to the reduction gear (2),
the reduction gear (2) comprises first and second assemblies (4, 5), the first assembly (4) is one of a harmonic gear, a cycloidal gear and a wobble gear, and the second assembly (5) is one of a single-step planetary gear, a multi-step planetary gear, a single-step stepped gear, a multi-step stepped gear, a single-step Wolfrom gear and a multi-step Wolfrom gear, and
gear ratios of the first and the second assemblies (4, 5) are so coordinated with one another so that the reduction gear (2) is not self-locking.

12. The actuator for generating a rotational positioning movement according to claim 11, wherein the first assembly (4) is arranged between the electric motor (1) and the second assembly (5).

13. The actuator for generating a rotational positioning movement according to claim 11, wherein the gear ratio of the first assembly (4) is less than 1:40.

14. The actuator for generating a rotational positioning movement according to claim 11, wherein the second assembly (5) comprises at least one planet carrier (11, 12, 24) and at least one sun gear (9, 10, 23).

15. The actuator for generating a rotational positioning movement according to claim 14, wherein the second assembly (5) comprises at least one ring gear (13, 14, 23, 25) and an output element of the reduction gear (2), on which the rotational positioning movement of the actuator is tapped, is formed by one of the ring gears (13, 14, 23, 25) or one of the planet carriers (11, 12, 24).

16. The actuator for generating a rotational positioning movement according to claim 15, wherein the actuator is part of a two-piece vehicle stabilizer bar for one of roll stabilization and ride height control of a vehicle.

17. The actuator for generating a rotational positioning movement according to claim 16, wherein the actuator is arranged between a first part (27) of the vehicle stabilizer bar and a second part (28) of the vehicle stabilizer bar, the first part (27) is connected to the output element of the reduction gear (2) and the second part (28) to a housing (3) of the actuator such that the actuator twists both the first and the second parts (27, 28) against one another for roll stabilization.

18. The actuator for generating a rotational positioning movement according to claim 16, wherein the actuator is connected, in a rotationally fixed manner, to a vehicle body such that the actuator twists one of a first part and a second part (27, 28), of the vehicle stabilizer bar, with respect to the vehicle body for roll stabilization.

19. The actuator for generating a rotational positioning movement according to claim 11, wherein the actuator is part of an electromechanically supported vehicle steering mechanism, and the actuator reinforces a steering force generated by a driver.

20. The actuator for generating a rotational positioning movement according to claim 11, wherein the actuator is part of a winch and an output element of the actuator is so connected to a rope drum of the winch, and, during rotational positioning movement of the actuator, a winch rope is one of wound on or wound off the rope drum.

21. An actuator for generating rotary positioning movement, the actuator comprising:
an electric motor (1) having an output that is rotationally fixed to a rotor (17);
a reduction gear (2) comprising a first gearing assembly (4) and a second gearing assembly (5) coaxially aligned with the first gearing assembly (4) and the electric motor (1),
the first gearing assembly (4) being one of a harmonic gear, a cycloidal gear and a wobble gear and having an input communicating with and is rotationally driven by the output of the electric motor (1),
the second gearing assembly (5) being one of a single-step planetary gear set, a multi-step planetary gear set, a single-step stepped gear set, a multi-step stepped gear set, a single-step Wolfrom gear set and a multi-step Wolfrom gear set, and an output of the first gearing assembly (4) communicating with and rotationally driving an input of the second gearing assembly (5), and an output of the second gearing assembly (5) providing the rotary positioning movement; and
the first gearing assembly (4) having a gear ratio in combination with a gear ratio of the second gearing assembly (5) such that the reduction gear (2) is prevented from being self-locking.
